(19) United States
(12) Patent Application Publication
(10) Pub. No.: US 2018/0315554 A1
(43) Pub. Date: Nov. 1, 2018

(54) SEPARATOR FOR ELECTRIC DOUBLE LAYER CAPACITOR

(71) Applicant: JAPAN VILENE COMPANY, LTD., Tokyo (JP)

(72) Inventors: Kengo NOGUCHI, Ibaraki (JP); Noriko MICHIHATA, Ibaraki (JP); Yoshinori SATO, Ibaraki (JP)

(73) Assignee: JAPAN VILENE COMPANY, LTD., Tokyo (JP)

(21) Appl. No.: 15/771,579

(22) PCT Filed: Nov. 4, 2016
(86) PCT No.: PCT/JP2016/082734

§ 371 Date: Apr. 27, 2018

(30) Foreign Application Priority Data
Nov. 4, 2015 (JP) 2015-216249

(51) Int. Cl. H01G 11/52; H01G 11/84

(52) U.S. Cl. CPC H01G 11/52; H01M 2/162; H01G 11/84

(57) ABSTRACT

The object of the present invention is to realize a separator that has excellent thermal stability in size, shape, and the like even in a high temperature environment. The separator comprises a nonwoven fabric obtained by subjecting a nonwoven fabric consisting of homo-PAN fibers to a flame proofing treatment in a temperature range of 210° C. to 300° C., wherein an I_{D}/I_{N} value, which is a ratio of an absorption peak intensity I_{D} of a carbon double bond-derived region (1580-1610 cm⁻¹) of the homo-PAN nonwoven fabric to an absorption peak intensity I_{N} derived from a nitrile group (2240 cm⁻¹), as determined by infrared absorption spectroscopy, is 0.07 or more; and wherein a fiber shape and size are stably maintained after immersion for 30 minutes in an electrolytic solution containing propylene carbonate at 140° C.

### TECHNICAL FIELD

The present invention relates to a separator suitable for an electric double layer capacitor for supplying power by recharging.

### BACKGROUND ART

In recent years, movement to suppress carbon dioxide emissions, a cause of global warming, has actively progressed, and hybridization that can suppress the consumption of fossil fuels in vehicles and other transportation methods is becoming established as a familiar technique. Electric storage devices, such as capacitors and lithium ion batteries for storing electric power, are put to practical use in a wide variety of application fields, because various electric products can be used even in environments where it is difficult to secure a power supply, and even now, a more efficient electric storage device is required.

As an example of such an electric storage device technology, in Japanese Unexamined Patent Publication (Kokai) No. 2007-266311 (Patent literature 1), a separator for use in an electric double layer capacitor is proposed. In this technique, an electric double layer capacitor having a structure in which a pair of electrodes is immersed in an ionic solution, and a separator for an electric double layer capacitor used for the same are disclosed. More particularly, the separator is composed of a fiber aggregate containing ultrafine fibers having an average fiber diameter of 0.2 Lm or less, and the ultrafine fibers are made of an acrylonitrile copolymer (acrylonitrile-acrylate copolymer) prepared by electrospinning, and insolubilization treatment on the ultrafine fibers is performed so as to be resistant to an electrolytic solution containing propylene carbonate as a solvent. The technique of Patent literature 1 is proposed for the purpose of preventing a short circuit between electrodes of a capacitor in the above-mentioned electrolytic solution containing tetraethylammonium tetrafluoroborate as an electrolyte, and it is stated that the thickness of the separator composed of the above-mentioned ultrafine fibers can be reduced, compared to a conventional separator using a polyimide porous membrane, and that the handling property is also excellent. Further, it is stated that heat treatment, electron beam irradiation, and gamma ray irradiation may be mentioned as the insolubilization treatment of ultrafine fibers, and that, in view of the degree of freedom of equipment, heat treatment at a temperature of 160-230° C. for about 30 seconds to 1 hour, or heat treatment at 150-200° C. for about 30 seconds to 2 minutes is preferable. In connection with this, Patent literature 1 exemplifies, as the above-mentioned acrylonitrile copolymer, methyl acrylate, vinyl acetate, methyl methacrylate, acrylic acid, methacrylic acid, vinyl chloride, vinylidene chloride, acrylamide, acrylic acid amide, and vinyl sulfonic acid, which can copolymerize with acrylonitrile.

Japanese Unexamined Patent Publication (Kokai) No. 2012-132121 (Patent literature 2) discloses techniques related to a polyacrylonitrile nonwoven fabric suitably obtained by electrospinning similar to that of Patent literature 1, and a nonaqueous energy device using the same as a high heat resistant separator. In Patent literature 2, in order to reduce the heat shrinkage of a separator exposed to the heat generated during the operation of a lithium ion secondary battery, a nonwoven fabric in which a flame proofing-promoting component is used as a copolymer component of polyacrylonitrile is used, and it is proposed to form a nonwoven fabric by electrospinning in which the resin is dissolved in a predetermined solvent in the spinning process. Patent literature 2 exemplifies, as the flame proofing component, acrylic acid, methacrylic acid, itaconic acid, crotonic acid, citraconic acid, ethacrylic acid, maleic acid, mesaconic acid, acrylamide, and methacrylamide. It is disclosed that polyacrylonitrile used in Patent literature 2 is preferably polymerized with the flame proofing-promoting component as a copolymer component, so that fusion or irregular deformation of polyacrylonitrile fibers after spinning does not occur, and it is considered preferable that the content of the copolymer component is 0.1 mol % or more. The fiber aggregate obtained by electrospinning is made to be infusible by heat treatment at a predetermined temperature. When the heat treatment temperature is 200° C. or less, the heat shrinkage of the nonwoven fabric may increase. When it is 300° C. or more, there is a possibility of a decrease in porosity between fibers, deformation of the nonwoven fabric sheet, and yarn breakage due to heat storage in the nonwoven fabric. Therefore, it is disclosed that the preferred temperature range for heat treatment is 210° C. to 295° C., and more preferably 220° C. to 290° C., and that heat treatment is carried out without applying tension.

As described above, an acrylic resin containing acrylonitrile is useful as a separator for an electric storage device. Japanese Unexamined Patent Publication (Kokai) No. 3-76822 (Patent literature 3) is also known as a technique similar to the flame proofing technique proposed in the aforementioned Patent literature 2. In this publication, as acrylic flame proofing fibers having high productivity and mechanical properties, a production technique for flame proofing an acrylic precursor under pressure is proposed. It is disclosed that the term “acrylic precursor” as used herein is obtained by using acrylic fibers as a raw material, and polymerizing an acrylic polymer constituting the acrylic fibers, with preferably 85 mol % or more of acrylic nitrile and 15 mol % or less of a vinyl type monomer, such as acrylic acid, methacrylic acid, itaconic acid, and alkali metal salts and ammonium salts thereof, lower alkyl esters, acrylamide and derivatives thereof, allylsulfonic acid, methallylsulfonic acid, and salts or alkyl esters thereof. These exemplified acrylic precursors are prepared to have a fineness of 2.0 d (denier) or less, and subjected to flame proofing in a heated atmosphere at 200-300° C. of air, oxygen, nitrogen dioxide, hydrogen chloride, or the like, preferably at a pressure of 0.05-100 kg/cm²-G. In this flame proofing, by the action of flame proofing according to the technique disclosed in Patent literature 3, the mechanical strength is improved as compared with the raw material fibers, and in this state, it is further heated at a temperature of 1000° C. or more. By this two-stage flame proofing treatment, calcination is performed as targeted carbon fibers.

The technique of Patent literature 3 described above is carried out for the purpose of imparting mechanical strength to the acrylic precursor which is a precursor of carbon fibers. In the Examples of the publication, there is a description that the flame proofing by the pressure and heating conditions described above was carried out by heat treatment for about 10 minutes. In Patent literature 3, there is an effect description that the time required for flame proofing can be shortened to ½- 1/20 compared with a previous technique, but there was still room for improvement in productivity. For this reason, Japanese Unexamined Patent Application Publication (Kokai) No. 2011-6681 (Patent literature 4) proposes a flame proofing technique in which an acrylonitrile polymer is heated in a supercritical fluid containing carbon dioxide as a main component, and the polymer is subjected to a cyclization/dehydration reaction. Patent literature 4 discloses in detail carbon fiber preparation techniques, including Patent literature 3, as background art. When carbon fibers are prepared from acrylic fibers, the acrylic fibers are heated in an oxidizing atmosphere at 200-300° C. to make flame proofed fibers (a flame proofing step). Subsequently, a carbonization step is carried out by heating the fibers in an inert gas at 1000-2000° C. in general. It is disclosed that it is preferable that, as a preliminary step of the carbonization step, a pre-carbonization step is carried out in an inert atmosphere furnace with an ascending temperature gradient of 400-700° C. There is a description that after these steps, the fibers are further treated in an inert gas at a higher temperature to make targeted graphite fibers.

Patent literature 4 discloses that, in the flame proofing step described above, a cyclization reaction of a nitrile group bonded to a polymer chain constituting an acrylonitrile polymer such as acrylic fibers, and a dehydrogenation reaction, in which the cyclized structure is oxidized or dehydrogenated to turn into a composite structure of a naphthyridine ring (a series of compounds in which two carbon atoms of a naphthalene ring are replaced by nitrogen) and an acridone ring (a ketone derivative in which the 9-position of acridine is oxonated: acridinone), occur to perform “flame proofing”. It is disclosed that, since such a flame proofing reaction progresses while diffusing oxygen from the surface of the acrylonitrile polymer toward the inside of the polymer in an oxidizing atmosphere at 200-300° C., cyclic compounds having carbon double bonds are distributed outside (near the outer periphery) of the object to be treated, and compounds without a carbon double bond, generated by only cyclizing nitrile groups, are mainly distributed inside of the object to be treated (in the vicinity of the center of the fiber), depending on the execution conditions of the flame proofing reaction, and the thickness of a fiber to be treated or the thickness of a film to be treated. The publication discloses, as a method of confirming the degree of progress of the flame proofing reaction of the acrylonitrile polymer, the following assignments of absorption peaks determined by a KBr tablet method using a micro infrared spectrometer.

Method A: The absorption peak (2240 cm⁻¹) of a nitrile group with respect to the absorption peak (2940 cm⁻¹) of C—H vibration,
Method B: The absorption peak (1610 cm⁻¹) of a carbon double bond of a naphthyridine ring generated by cyclization, and
Method C: The absorption peak (1580 cm⁻¹) of a carbon double bond generated by dehydrogenation.

Among them, there is an effect description that, when scanning and measuring were carried out, using the micro infrared spectrometer, in the plane direction perpendicular to the fiber axis of a fiber, i.e., in the cross-sectional direction of the fiber, it was confirmed that improvement in uniformity of the structure after the flame proofing reaction on the fibers was improved, by plotting the absorption peak intensity of the carbon double bond generated by dehydrogenation by Method C and the fiber diameter of the fiber after the flame proofing.

It is disclosed that the term “acrylonitrile polymer” as used in Patent literature 4 means a polymer obtained by homopolymerizing acrylonitrile (a homopolymer) and/or a copolymer of acrylonitrile and a monomer copolymerizable therewith. In connection with this, it is considered preferable that the content of an acrylonitrile unit contained in the acrylonitrile polymer is 90 mass % or more, and that it is 95 mass % or more and 98 mass % or less in the case of seeking quality and performance on carbon fibers after carbonization which is performed following the flame proofing reaction.

Further, as the above-mentioned monomer copolymerizable with acrylonitrile, one compound or two or more compounds selected from the group consisting of: acrylate esters typified by methyl acrylate, ethyl acrylate, isopropyl acrylate, n-butyl acrylate, 2-ethylhexyl acrylate, 2-hydroxyethyl acrylate, hydroxypropyl acrylate, and the like;

methacrylate esters typified by methyl methacrylate, ethyl methacrylate, isopropyl methacrylate, n-butyl methacrylate, n-hexyl methacrylate, cyclohexyl methacrylate, lauryl methacrylate, 2-hydroxyethyl methacrylate, hydroxypropyl methacrylate, diethylaminoethyl methacrylate, and the like;
unsaturated monomers, such as acrylic acid, methacrylic acid, itaconic acid acrylamide, N-methylol acrylamide, diacetone acrylamide, styrene, vinyltoluene, vinyl acetate, vinyl chloride, vinylidene chloride, vinyl bromide, vinylidene bromide, vinyl fluoride, vinylidene fluoride, and the like; and
p-sulfophenyl methallyl ether, methallylsulfonic acid, allylsulfonic acid, styrenesulfonic acid, 2-acrylamido-2-methylpropanesulfonic acid, and alkali metal salts thereof; are exemplified.

### CITATION LIST

### Patent Literature

[Patent literature 1] Japanese Unexamined Patent Publication (Kokai) No. 2007-266311 ([Claims], [0005]-[0010], [0018], [0022], [Examples], and the like)
[Patent literature 2] Japanese Unexamined Patent Publication (Kokai) No. 2012-132121 ([Claims], [0001], [0019]-[0024], [0028], [0029], [0032], [0033], [Examples], and the like)
[Patent literature 3] Japanese Unexamined Patent Publication (Kokai) No. 3-76822 ([Claims], [Solution to Problem], [Examples], and the like)
[Patent literature 4] Japanese Unexamined Patent Publication (Kokai) No. 2011-6681 ([Claims], [0001]-[0006], [0014], [0015], [0030]-[0032], and the like)

### SUMMARY OF INVENTION

### Technical Problem

As can be understood from the above-mentioned background art, various copolymer components are known for acrylic resins, and various proposals have been made to improve productivity and quality in obtaining carbon fibers. The present applicant has also proposed, in the aforementioned Patent literature 1, the acrylonitrile copolymer (acrylonitrile-acrylate copolymer) as a separator for an electric double layer capacitor. However, along with the progress of higher efficiency of electric storage devices such as a capacitor or the like, evaluation and selection under more severe conditions are desired, rather than the resistance of a separator against an electrolytic solution. Among such social demands, attention was focused on propylene carbonate, which had been put into practical use as an electrolytic solution of the above-mentioned electric double layer capacitor, and a separator having higher stability was examined. When operated stably as an electricity storage device, the separator immersed in the electrolytic solution containing an electrolyte also needs to withstand a high temperature, and it is necessary to stably maintain fine porosities in order to exhibit high output. Therefore, when the flame proofing of the acrylic resin is carried out for improving the thermal stability of the separator, it is necessary to closely monitor the structural change in the copolymer generated by the heat treatment, by a confirmation method, such as the above-mentioned infrared absorption spectrum. However, most of the acrylic resins are mainly copolymers of acrylonitrile and a second component (for example, a vinyl-based monomer or the like, as described in Patent literature 3), as disclosed in each of the aforementioned patent literatures. For this reason, the presence of the second component in the acrylic resin reduces the cohesive force of the molecule, and as a result, there is a problem that the acrylic resin tends to dissolve in an organic solvent used in the aforementioned electrolytic solution or a spinning solution, such as propylene carbonate, ethylene carbonate, dimethylformamide, dimethylacetamide, and the like. Further, in order to suppress the dissolution in the organic solvent due to the second component present in the acrylic resin, it is necessary to treat the acrylic resin at a high temperature of 200° C. or more for several hours for the complete flame proofing of the second component, and there is a problem that productivity of the material used as the separator is low.

Therefore, the inventors of the present application focused attention on propylene carbonate, which is known as a solvent of a general electrolytic solution for a capacitor, and even when the electrolytic solution was exposed to the flash point of 132° C., as the most severe temperature to which the electrolytic solution was exposed, the inventors intensively investigated separator materials capable of maintaining stability such as shape, size, and the like, and the present invention has been completed. The present invention has been made in view of the above-described conventional problems, and an object is to realize a separator excellent in thermal stability such as size, shape, and the like, even under a high temperature environment.

### Solution to Problem

In order to achieve the object, the separator for an electric double layer capacitor of the present invention, said separator being characterized in that the separator comprises a nonwoven fabric obtained by subjecting a nonwoven fabric consisting of homo-polyacrylonitrile (homo-PAN) fibers to a flame proofing treatment in a temperature range of 210° C. to 300° C., wherein an I_{D}/I_{N} value, which is a ratio of an absorption peak intensity I_{D} of a carbon double bond-derived region (1580-1610 cm⁻¹) of the homo-PAN nonwoven fabric to an absorption peak intensity I_{N} derived from a nitrile group (2240 cm⁻¹), as determined by infrared absorption spectroscopy, is 0.07 or more; wherein a fiber shape is maintained after immersion for 30 minutes in an electrolytic solution containing propylene carbonate at 140° C.; and both dimensional change rates in longitudinal and lateral directions are 0% or more.

The term “homo-PAN” as used herein means a polymer in which both the carbon double bond (Method B as described above) of a naphthyridine ring generated by cyclization, and/or the carbon double bond generated by dehydrogenation, as described in Patent literature 4, are formed by a flame proofing treatment in the molecular chain of a homopolymer only composed of acrylonitrile as the raw material resin. As will be described in detail with reference to Examples and Comparative Examples, the nitrile group, which is identified by the absorption peak intensity I_{N} substantially as the single functional group, is abundant in the homopolymer of acrylonitrile, as an object to be treated before the flame proofing treatment, and then, the proportion of the carbon double bond, which is generated by the heat treatment and which is identified by the absorption peak intensity I_{D}, increases, and therefore, it is presumed that, in the polymer used in the present invention in which the above-mentioned ratio is equal to or higher than the predetermined value, the dimensional stability as a separator in an electrolytic solution is excellent, and the porosity by fiber shape is maintained.

The state in which the above-mentioned “dimensional change rate” is “0% or more” means that, after the separator of the present invention is immersed for 30 minutes in an electrolytic solution containing propylene carbonate at 140° C., dissolution, or shrinkage in which the above-mentioned value is represented by a negative number does not occur, and the porosity is maintained. As the electrolytic solution, an electrolytic solution in which propylene carbonate [C₄H₆O₃] is used as a solvent, and tetraethylphosphonium-tetrafluoroborate, or tetraethyl ammonium tetrafluoroborate [(C₂Hs)₄NBF₄], which is used in, for example, the electric double layer capacitor disclosed in the aforementioned Patent literature 1, is contained as an electrolyte; or the like, may be used.

### Advantageous Effects of Invention

By applying the constitution of the present invention, a separator excellent in thermal stability in an electrolytic solution such as propylene carbonate, and capable of maintaining the porosity can be realized, and as a result, it is possible to provide an electric storage device having excellent characteristics.

### BRIEF DESCRIPTION OF THE DRAWINGS

FIG. 1 is a characteristic curve diagram, in which the vertical axis represents absorbance and the horizontal axis represents wave number, in order to explain the results of infrared absorption spectroscopy in Examples and the like of the present invention.

### DESCRIPTION OF EMBODIMENTS

Hereinafter, preferred embodiments of the present invention will be described. In the following description, in order to facilitate an understanding of the present invention, the present invention will be explained while exemplifying specific numerical conditions, but the present invention is not limited to the preferred embodiments, and may be modified arbitrarily and preferably within the scope of the object of the present invention.

Preferred embodiments of the separator of the present invention will be described by exemplifying preferred manufacturing processes thereof. First, acrylonitrile, which is a raw material of the separator of the present invention, is homopolymerized by well-known techniques to obtain a polyacrylonitrile polymer having a predetermined average molecular weight, and a spinning solution is prepared by using one solvent, or two or more mixed solvent selected from N, N-dimethylformamide, N, N-dimethylacetamide, dimethylsulfoxide, acetone, acetonitrile, sodium thiocyanate, aqueous zinc chloride solution, and nitric acid, which are good solvents for acrylic resins. The homopolymer contained in this spinning solution is preferably a weight average molecular weight (Mw) of 10,000 to 1,000,000. It is not preferable that the weight average molecular weight is lower than 10,000, because the viscosity of the spinning solution is low and in a liquid state, so that it becomes a film shape with voids disappeared and tends to become poor in porosity. On the contrary, when the weight average molecular weight is higher than 1,000,000, since the spinning solution discharged from the nozzle is solidified quickly due to high viscosity, a large number of fluffy fibers are generated on the sheet, and as a result, a porous structure is formed, but efficient spinning may be difficult by disturbing the electric field between the nozzle and the collection conveyor.

Next, spinning is performed with this spinning solution to obtain a sheet form to be subjected to a flame proofing treatment. As this sheet form, it is desirable to be composed of ultrafine fibers of 1 m or less in order to arbitrarily and preferably adjust the viscosity of the spinning solution and ensure insulation as a separator, and it is preferable to sufficiently secure a single fiber strength by setting the fiber diameter to 100 nm or more. The formation of such ultrafine fibers is preferably performed by electrospinning proposed by the applicant and disclosed in Patent literature 1, as a technique for forming nonwoven fabrics capable of spinning fibers substantially without heating and capable of simultaneously spinning and sheeting.

By preparing a sheet made of the homopolymer in this manner and performing a flame proofing treatment at a predetermined temperature condition, it can be finished into a polymerization form usable as a separator having dimensional stability in an electrolytic solution, as defined in the present application. The temperature condition for flame proofing can be arbitrarily and preferably set, so long as a heat quantity can be given to the preferable condition of the absorption peak intensity ratio of the present invention described above. As an apparatus for performing such a flame proofing treatment, an apparatus which indirectly heats a sheet to be treated by applying hot air or far infrared rays; an apparatus which heats directly an object to be treated by providing multiple cylindrical heat sources, and placing the object along the peripheral edge of the heat source; and the like, are known. Conditions related to flame proofing, such as the form of the heating apparatus, heating temperature, time, and the like, can be combined in various ways, and it is preferable to heat the homo-PAN nonwoven fabric at a processing temperature of 210-300° C. in air atmosphere and atmospheric pressure.

In the present invention, the case where resistance to a specific electrolytic solution is evaluated is exemplified, but the separator of the present invention can exhibit excellent characteristics, also with respect to well-known electrolytic solutions having polarity. Therefore, by selecting, instead of propylene carbonate exemplified as a solvent of the electrolytic solution, dimethyl carbonate, diethylene carbonate, sulfolane, dimethylsulfone, ethylmethylsulfone, ethylisopropylsulfone, acetonitrile, or the like, and by selecting various combinations with well-known electrolytes, the same effects as those of the specific electrolytic solution used for the evaluation can be expected.

### Examples

Hereinafter, as examples of the present invention, the results of evaluating the dimensional stability in an electrolytic solution by preparing separators made of various nonwoven fabrics including the preferred embodiments of the present invention will be described, but the present invention is not limited to the following examples, and it is to be understood that shapes, arrangement relationships, numerical conditions, and the like can be arbitrarily and preferably designed within the scope of the object of the present invention.

### (Preparation of Polymers and Spinning Solutions to be Evaluated)

First, to prepare spinning solutions, three types of polymers, i.e., two types of homopolymers, in which only acrylonitrile was homopolymerized, having weight average molecular weights of 550,000 and 370,000; and staple fibers “Vonnel D122” (manufactured by MITSUBISHI RAYON CO., LTD., product name, average molecular weight: 200,000, hereinafter abbreviated to copolymerized PAN) consisting of an acrylonitrile-acrylate copolymer, which is disclosed in the aforementioned Patent literature 1, were provided. These polymers were separately dissolved in N,N-dimethylformamide to prepare spinning solutions having the following viscosities. Details of these polymers are listed in Table 1 below.

Spinning solution viscosity of homo-PAN (weight average molecular weight: 550,000): 1200 mPa·s (polymer concentration: 10.5 wt %),
Spinning solution viscosity of homo-PAN (weight average molecular weight: 370,000): 1000 mPa·s (polymer concentration: 13.0 wt %), and
Spinning solution viscosity of copolymerized PAN (weight average molecular weight: 200,000): 2400 mPa·s (polymer concentration: 16.0 wt %).

### (Sheet Formation by Electrospinning)

Subsequently, using these spinning solutions as described above, sheets were formed by electrospinning. The sheet formation was carried out using an apparatus having the constitution disclosed in the aforementioned Patent literature 1 (see Figures attached to the patent publication). More particularly, multiple nozzle groups were fixed to a chain-like support at a predetermined pitch, and the endless belt-shaped support was operated by a driving motor and a pair of sprockets. While supplying a spinning solution to each nozzle, by applying a predetermined voltage to each nozzle, an electric field was applied to each polymer to form fibers. These fibers were collected on a belt-like collector (the belt-like collector was driven in the same manner as the above-mentioned chain-like support, and it had a separation distance of about 80-100 mm from the tip of the nozzles, and its surface was grounded by conductivity treatment), and the sheet was formed by repeating lamination until a predetermined mass per unit area was reached. Meanwhile, these devices were assembled in a chamber isolated from the atmosphere, room air (25° C., relative humidity 17-23%) humidified by a blower was introduced into the chamber, and the inner atmosphere containing the solvent was discharged out of the chamber by the operation of an exhaust fan.

### (Flame Proofing Treatment)

The fiber aggregates consisting of each polymer, which had been sheeted in this manner, were subjected to a flame proofing treatment in an air atmosphere under atmospheric pressure, using three types of heat treatment apparatus, by combinations of treatment temperatures of 180-255° C. and heating times (see Table 1), to obtain nonwoven fabrics consisting of each polymer. As the three pieces of apparatus that provide heat to these nonwoven fabrics, a heat treatment apparatus (hereinafter referred to as a direct heating apparatus, or represented as “direct” in Table 1 below), in which multiple cylindrical drums capable of controlling a surface temperature by a heat medium or the like, such as a calendar, were provided, and the object to be treated was placed along the drum surfaces, was mainly used, and in addition, a dryer that applied hot air to the object to be treated, or a heating apparatus that irradiated far infrared rays (hereinafter referred to as an indirect heating apparatus, or represented as “indirect” in Table 1 below) was used. In connection with this, in order to ensure the insulation of a separator, which was the object to be treated, a device constitution in which the above “drums” were coated with an insulating material such as glass or ceramics was adopted.

(Measurement of Ratio I_{D}/I_{N} by Infrared Absorption Spectroscopy)

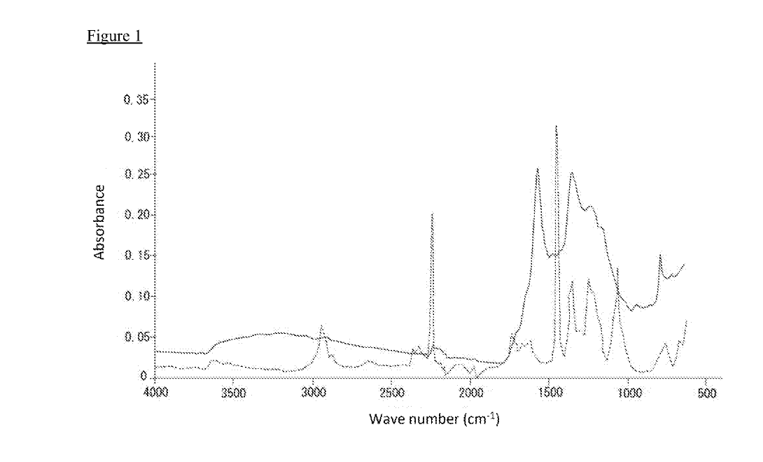

With respect to the nonwoven fabrics consisting of each polymer, which had been prepared in this manner, peak intensities of an absorption peak (2240 cm⁻¹) of a nitrile group, an absorption peak (1610 cm⁻¹) of a carbon double bond of a naphthyridine ring generated by cyclization, and an absorption peak (1580 cm⁻¹) of a carbon double bond generated by dehydrogenation, were determined from the chart of each fiber aggregate obtained by attenuated total reflection (ATR); the degree of progress was confirmed with these peak intensities; and the consistency with the evaluation of dimensional stability in an electrolytic solution, as described below, was verified. The I_{D}/I_{N} value, which was a ratio of an absorption peak intensity I_{D} of a carbon double bond-derived region (1580-1610 cm⁻¹) to an absorption peak intensity I_{N} derived from a nitrile group (2240 cm⁻¹), as disclosed in the aforementioned Patent literature 4, was determined (see Table 1). FIG. 1 is a characteristic curve diagram comparing the ATR charts of Example 7 (solid line) treated at 255° C. for 30 minutes, in which the degree of a flame proofing treatment was highest in the samples listed in Table 1, and Comparative Example 2 (dotted line) treated at 210° C. for 34 seconds, in which the degree of a flame proofing treatment was low. As can be understood from FIG. 1, the larger the amount of heat applied to the sample (proportional to the product of temperature and time), the smaller the peak intensity (2240 cm⁻¹) of the nitrile group (solid line corresponding to the Example<dotted line corresponding to the Comparative Example); and as the peak intensity (1580-1610 cm⁻¹) of the carbon double bond becomes larger, it is considered that the flame proofing reaction (solid line corresponding to the Example>dotted line corresponding to the Comparative Example) is progressing. This change in infrared absorption spectrum was verified by the evaluation of dimensional stability in an electrolytic solution, as described below.

### (Evaluation of Dimensional Stability in Electrolytic Solution)

The fiber diameter of the constituent fibers of the nonwoven fabrics consisting of each polymer after flame proofing was actually measured at 5 points by an electron microscope, and as a result, the constituent fibers were ultrafine fibers having a fiber diameter of about 300 nm on average in any nonwoven fabric. Each of these nonwoven fabrics was cut as a measurement piece of 50 mm in the longitudinal direction, which was the production direction, and 40 mm in the lateral direction corresponding to the width direction orthogonal thereto, and used as samples to be evaluated. These evaluation samples were immersed in petri dishes with 20 mL of a commercially available electrolytic solution for capacitor “LIPASTE/EAF 1N” (manufactured by Tomiyama Pure Chemical Industries, Ltd., product name: containing 17.3% of tetraethylammonium tetrafluoroborate [(C₂Hs)₄NBF₄] as an electrolyte in propylene carbonate as a solvent), and heated by allowing the dishes to stand in a hot air oven at 140° C. for 30 minutes. After this, the appearance of each sample was confirmed over time, the dimension after 30 minutes was measured, and the change from the initial dimension was recorded. The results of the evaluation of dimensional stability in the electrolytic solution, and details concerning the series of polymers described above are shown in Table 1. As previously explained, the term “Longitudinal” in the dimensional change rate column represents the flow direction of a base fabric during nonwoven fabric production, and the term “Lateral” represents the width direction of a base fabric during nonwoven fabric production.

TABLE 1

| | | | C | | | D | | | E* | |
|---|---|---|---|---|---|---|---|---|---|---|
| | A | B | F | G | H | I_{D} | I_{N} | I_{D}/I_{N} | J | K |
| Ex. 1 | Homo-PAN | 3.2 | Direct | 230 | 24 | 0.0008 | 0.0114 | 0.070 | +6% | +10% |
| | (550,000) | | | | | | | | | |
| Ex. 2 | Homo-PAN | 3.2 | Direct | 230 | 72 | 0.0011 | 0.0102 | 0.108 | +6% | +10% |
| | (550,000) | | | | | | | | | |
| Ex. 3 | Homo-PAN | 3.2 | Direct | 230 | 120 | 0.0018 | 0.0107 | 0.168 | +6% | +9% |
| | (550,000) | | | | | | | | | |
| Ex. 4 | Homo-PAN | 3.2 | Direct | 230 | 19 | 0.0009 | 0.0101 | 0.089 | +6% | +10% |
| | (370,000) | | | | | | | | | |
| Ex. 5 | Homo-PAN | 4.6 | Indirect | 210 | 1800 | 0.0027 | 0.0054 | 0.500 | +8% | +8% |
| | (550,000) | | | | | | | | | |
| Ex. 6 | Homo-PAN | 4.6 | Indirect | 230 | 1800 | 0.0038 | 0.0047 | 0.809 | +6% | +8% |
| | (550,000) | | | | | | | | | |
| Ex. 7 | Homo-PAN | 4.6 | Indirect | 255 | 1800 | 0.0077 | 0.0006 | 12.83 | 0% | 0% |
| | (550,000) | | | | | | | | | |
| Com. | Co-PAN | 5.0 | Indirect | 180 | 30 | 0.0002 | 0.0057 | 0.035 | x | x |
| Ex. 1 | (200,000) | | | | | | | | | |
| Com. | Homo-PAN | 4.6 | Direct | 210 | 34 | 0.0001 | 0.0067 | 0.015 | x | x |
| Ex. 2 | (550,000) | | | | | | | | | |
| Com. | Homo-PAN | 4.6 | Direct | 210 | 27 | 0.0005 | 0.0112 | 0.045 | x | x |
| Ex. 3 | (370,000) | | | | | | | | | |
| Com. | Homo-PAN | 4.6 | Indirect | 230 | 24 | 0.0005 | 0.0120 | 0.042 | x | x |
| Ex. 4 | (550,000) | | | | | | | | | |
| Com. | Co-PAN | 5.0 | Direct | 230 | 24 | 0.0038 | 0.0187 | 0.203 | −30% | −25% |
| Ex. 5 | (200,000) | | | | | | | | | |

A: Consttuent resin (average molecular weight)
B: Mass per unit area (g/m²)
C: Conditions for flame proofing treatment
D: Infrared absorption peak intensity
E: Dimension change rate
F: Heating apparatus
G: Temperature (° C.)
H: Time (seconds)
J: Longitudinal
K: Lateral
Co-PAN: Copolymerized PAN
*The symbol “x” in the dimension change rate column represents that the sample was dissolved in propylene carbonate at 140° C. within 30 minutes, and as a result, the dimension change could not be measured. A value with “+” represents that the dimension of a base fabric increased from the initial dimension, and a value with “−” represents that the dimension of a base fabric decreased from the initial dimension.

As shown in Table 1, in Examples 1 to 7, the homopolymer obtained by homopolymerizing acrylonitrile was used as a raw material, and a sheet was formed by electrospinning, and subjected to a flame proofing treatment at 180-255° C. to obtain homo-PAN nonwoven fabrics. On the contrary, in the four samples of Comparative Example 1, in which the copolymerized PAN (acrylonitrile-acrylate copolymer) disclosed in the aforementioned Patent literature 1 was used as a raw material, and a flame proofing treatment at 180° C. for 30 seconds was carried out using a far infrared irradiation apparatus as the indirect heating apparatus; Comparative Example 2, in which the same resin as that used in the series of Examples was subjected to a flame proofing treatment at 210° C. for 34 seconds; Comparative Example 3, in which a resin different in only molecular weight from that used in the series of Examples was subjected to a flame proofing treatment at 210° C. for 27 seconds; and Comparative Example 4, in which the same resin as that used in the series of Examples was subjected to a flame proofing treatment at 230° C. for 24 seconds; the samples were dissolved in the electrolytic solution at 140° C., which was used in the evaluation test of the dimensional stability in the electrolytic solution as described above, and as a result, the dimension could not be determined. From the comparison between Examples 1 to 7 and Comparative Examples 1 to 4, the fiber shape disappeared in Comparative Examples 1 to 4, in which the above-mentioned I_{D}/I_{N} ratio was less than the value “0.07” of Example 1 as a boundary, and therefore, it has been found that the samples of Comparative Examples 1 to 4 do not function as a separator. From the evaluation results of these four Comparative Examples, it is considered that, in a separator having a value lower than the above-mentioned boundary of the I_{D}/I_{N} ratio, the degree of cyclization reaction was insufficient due to the lack of heat treatment, and therefore, dimensional stability in the electrolytic solution at high temperature could not be obtained.

Comparative Example 5 is composed of the same “copolymerized PAN” as that of Comparative Example 1, and is subjected to a flame proofing treatment similar to that of Example 1, in comparison with Comparative Example 1. It was observed that flame proofing was achieved by this heat treatment in Comparative Example 5 to the extent that it met the requirement that the I_{D}/I_{N} ratio is “0.07 or more”, as a feature of the present invention. However, in the sample of Comparative Example 5, dimensional shrinkage of about 20-30% was observed by the evaluation test in the electrolytic solution at high temperature. Although this cause is not clear, similarly to Comparative Example 1, since the conventionally known “copolymerized PAN” containing the second component is used as the raw material resin, it is presumed that a molecular structure having more affinity for a polar organic solvent, such as dimethylacetamide, than the “homo-PAN” as used herein, is formed. Therefore, it is considered that even if flame proofing was achieved, similarly to Examples 1 to 7, to the extent that it met the requirement that the I_{D}/I_{N} ratio is “0.07 or more”, as a feature of the present invention, since the copolymer component remained in the constituent fibers of a separator, it exhibited affinity for the electrolytic solution containing propylene carbonate, which was a polar organic solvent, and as a result, shrinkage occurred. As described above, we could only just confirm the dimension and shape of the sheet of Comparative Example 5 by the above-mentioned test. However, the porosity required as a separator was extremely unstable, and therefore, it was judged that the function as a sufficient separator could not be exhibited, in comparison with the series of Examples.

### INDUSTRIAL APPLICABILITY

By applying the present invention, a separator excellent in heat resistance during operation can be provided, and therefore, various electric storage devices excellent in operation stability can be realized.

Although the present invention has been described with reference to specific embodiments, various changes and modifications obvious to those skilled in the art are possible without departing from the scope of the appended claims.

1. A separator for an electric double layer capacitor, wherein the separator comprises a nonwoven fabric obtained by subjecting a nonwoven fabric consisting of homo-polyacrylonitrile (homo-PAN) fibers to a flame proofing treatment in a temperature range of 210° C. to 300° C., wherein an I_{D}/I_{N} value, which is a ratio of an absorption peak intensity I_{D} of a carbon double bond-derived region (1580-1610 cm⁻¹) of the homo-PAN nonwoven fabric to an absorption peak intensity I_{N} derived from a nitrile group (2240 cm⁻¹), as determined by infrared absorption spectroscopy, is 0.07 or more; wherein a fiber shape is maintained after immersion for 30 minutes in an electrolytic solution containing propylene carbonate at 140° C.; and both dimensional change rates in longitudinal and lateral directions are 0% or more.
